(19) United States
(12) Patent Application Publication
(10) Pub. No.: US 2025/0079512 A1
(43) Pub. Date: Mar. 6, 2025

(54) COMB-BRANCHED POLYMER/SILICA NANOPARTICLES HYBRID POLYMER ELECTROLYTES FOR SOLID-STATE LITHIUM METAL SECONDARY BATTERIES

(71) Applicant: Evonik Operations GmbH, Essen (DE)

(72) Inventors: Feifei Wang, Shanghai (CN); Xiaochuan Xu, Shanghai (CN); Jing Feng, Shanghai (CN); Xiaowei Tian, Shanghai (CN); Minghui Chen, Shanghai (CN); Huiming Xiong, Shanghai (CN); Wei Wei, Shanghai (CN); Donglei You, Shanghai (CN)

(73) Assignee: Evonik Operations GmbH, Essen (DE)

(21) Appl. No.: 18/689,909

(22) PCT Filed: May 25, 2021
(86) PCT No.: PCT/CN2021/095868

§ 371 Date: Mar. 7, 2024

(51) Int. Cl. H01M 10/0565; C08G 65/08; C08K 3/36; H01M 4/38; H01M 10/0525

(52) U.S. Cl. CPC H01M 10/0565; C08G 65/08; C08K 3/36; H01M 4/382; H01M 10/0525; C08K 2201/005; H01M 2300/0091

(57) ABSTRACT

A material composition to prepare a polymer electrolyte precursor composition capable to form a solid polymer electrolyte, which has: A) a comb-branched polymer with pendant functional groups; B)surface-modified silica particles; and C) a polymerizable solvent or a crosslinker; wherein the silica particles are capable to be dispersed in the polymerizable solvent or a non-polymerizable volatile organic solvent and form a colloidal silica dispersion can be made. The material composition can be used in preparation of a solid polymer electrolyte in a lithium ion battery to improve performance, a polymer electrolyte precursor composition, a preparation method of a solid polymer electrolyte, a method to prepare a lithium ion battery, a solid polymer electrolyte, an electrochemical device and a device.

### TECHNICAL FIELD

The present invention relates to the field of solid polymer electrolytes, specifically, the preparation and development of the comb-branched polymer/silica nanoparticles hybrid polymer electrolytes for all-solid-state lithium ion battery, especially lithium metal secondary batteries.

### BACKGROUND ART

Conventional liquid electrolytes-based lithium-ion batteries might suffer from serious safety hazards. Solid polymer electrolytes (SPEs) have great potential for the next generation batteries with high security and high energy density. SPEs have several specific advantages such as high safety, flexibility, easy fabrication, and good physicochemical stability. Since Wright et al. discovered the dry polymer electrolytes of poly(ethylene oxide) (PEO) and alkali salts in 1973, a significant number of polymer hosts for lithium batteries have been developed. Among all the polymers, PEO is a very promising candidate due to its decent dielectric constant, excellent lithium salts solubility, and good compatibility with the lithium metal. However, the typical linear PEO cannot meet the requirement of industrial production because of insufficient ionic conductivity (10⁻⁸˜10⁻⁵ S cm⁻¹ at room temperature) and low lithium ion transference number (generally <0.2). These disadvantages are originated from the high crystallinity at ambient temperature and the strong ability of trapping lithium ions, which will hinder the ionic migration especially at low temperature. While, if running above the melting point of PEO electrolytes, there is not any mechanical strength to overcome the uncontrollable lithium dendrite growth. To overcome the aforementioned deficiencies, crosslinked network has been employed to improve the mechanical stability. However, the ionic conductivity remains low (i.e.<10⁻⁴ S cm⁻¹) because of the restrained segmental motion by the cross-linking junctions. To enhance the polymer chain motion, liquid additives have been incorporated; however, the formed gel electrolytes generally suffer poor mechanical performance. Branched comb-like polymer is an alternative candidate to enhance the ionic conductivity, which is usually viscous liquid and lacks mechanical strength. Currently, to achieve viable SPEs that simultaneously possess strong mechanical properties and a high conductivity, especially at ambient temperature, is still a great challenge.

Recently, polymer-inorganic composite electrolytes have attracted great interest, because they can effectively enhance not only ionic conductivity but also mechanical properties of electrolytes. The inorganic fillers are generally divided into two basic types: inert ceramic powders/non-active fillers (e.g. silica nanoparticles) and active fillers (e.g. NASICON and garnet oxide fillers). Although the polymer-inorganic composite electrolytes with additional inorganic fillers are proved to improve the ionic conductivity without sacrificing the mechanical strength, several issues still need to be solved, including the agglomeration of ceramic fillers and weak interaction between fillers and polymers. The type of comb-branched PEO with short ethylene oxide (EO) branches (PEO^{B}) is designed as an effective way to suppress the crystallization and enhance cycling performance. However, the PEO^{B} is usually a viscous liquid and possesses poor mechanical property at room temperature. In addition, the ionic conductivity and lithium ion transference number still need to be improved.

### SUMMARY OF THE INVENTION

The inventors surprisingly found that the filler of colloidal surface-modified silica (i.e., silicon dioxide) nanoparticles together with a polymerizable solvent or a crosslinker exhibits excellent dispersion and good polymer-filler interaction in comb-branched polymer electrolytes and can be used as additives in comb-branched polymer electrolytes to improve the performance of batteries. Particularly, the comb-branched polymer such as comb-branched PEO and colloidal surface-modified silica nanoparticles have a synergistic effect to form hybrid polymer electrolytes with excellent polymer electrolyte performance including ionic conductivity, lithium ion transference number and mechanical properties.

The present invention provides a material composition to prepare a polymer electrolyte precursor composition capable to form a solid polymer electrolyte, particularly an in situ crosslinked solid polymer electrolyte, wherein the material composition comprises:
A) a comb-branched polymer (such as a comb-branched polyether) with pendant functional groups such as allyl groups;
B) surface-modified silica particles; and
C) a polymerizable solvent (C1), which is selected from monomers, oligomers and/or prepolymers convertible to form a copolymer by nonradical or radical reactions with the comb-branched polymer, especially with the pendant functional groups; or a crosslinker (C2) capable to react with the pendant functional groups in the comb-branched polymer and form a crosslinked material;

wherein the surface-modified silica particles are capable to be dispersed in the polymerizable solvent or a non-polymerizable volatile organic solvent and form a colloidal silica dispersion.

In such colloidal silica dispersion, the surface-modified silica particles are homogenously dispersed in the polymerizable solvent or the non-polymerizable volatile organic solvent and form a colloidal silica dispersion. In other words, such colloidal silica dispersion may be a homogeneous silica dispersion in the non-polymerizable volatile organic solvent, or the polymerizable solvent.

The amount of the silica particles (B) is typically from 1 to 30 wt. %, for example, 1-20 wt. %, preferably 3-20 wt. %, more preferably 5-20 wt. %, for example, 5-19 wt. %, 5-18 wt. %, 5-17 wt. %, 5-16 wt. %, even more preferably 5-15 wt. %, for example 5-11 wt. %, 5-12 wt. %, 5-13 wt. %, or 5-14 wt. % based on the weight of the comb-branched polymer.

In some embodiments, the surface-modified silica particles are prepared from evaporating a colloidal silica dispersion comprising the surface-modified silica particles and a non-polymerizable volatile organic solvent, or are evaporated product of a colloidal silica dispersion comprising or consisting of the surface-modified silica particles and a non-polymerizable volatile organic solvent. In such case, the non-polymerizable volatile organic solvent is evaporated, thus the evaporated product of the surface-modified colloidal silica dispersion may essentially consist of the surface-modified silica particles.

In some embodiments, the surface-modified silica particles are dispersed in the polymerizable solvent or a non-polymerizable volatile organic solvent and form a colloidal silica dispersion.

The polymerizable solvent and the comb-branched polymer copolymer may form a copolymer with a three-dimensional network.

The material composition of the invention may be used to prepare a polymer electrolyte precursor composition capable to form an in situ crosslinked solid polymer electrolyte in a lithium ion battery, especially a lithium metal secondary battery, which has improved performance such as improved comprehensive performance or improved electrolyte mechanical property, ionic conductivity (e.g. below 40° C., below 35° C., or at room temperature), lithium transference number, initial discharge capacity and cycling stability. Example of improved comprehensive performance may include comparative ionic conductivity but much better lithium transference number and mechanical property.

The present invention further provides a use of the material composition of the invention in preparation of a solid polymer electrolyte in a lithium ion battery, especially a lithium metal secondary battery, to improve performance such as electrolyte mechanical property, ionic conductivity, lithium transference number, initial discharge capacity and/or cycling stability.

As used herein, the term “surface-modified” in the invention refers to “organically surface modified”, the term “surface-modified colloidal silica dispersion” refers to a colloidal silica dispersion wherein the silica is organically surface modified. The silica may be modified by organic compounds including organic silicon compounds such as silane.

In the invention, the silica is surface modified, especially by silane, e.g. organofunctional silanes, especially alkoxy silanes.

In the invention, the term “solid polymer electrolyte” refers to all-solid-state polymer electrolyte and/or quasi-solid-state polymer electrolyte.

In the invention, the colloidal silica dispersion is not an unstable suspension of silica particles. Typically, the colloidal silica dispersion is a homogeneous and stable dispersion of silica particles. In some embodiments, the colloidal silica dispersion is transparent or clear.

As used herein, the term “evaporated product of a colloidal silica dispersion” refers to the evaporated product of a colloidal silica dispersion wherein the solvent of the colloidal silica dispersion is evaporated, preferably under reduced pressure (e.g. vacuum), preferably before (e.g. 0.01-24 hours before) it is used in preparation of solid polymer electrolytes. Such evaporated product of the dispersion is solid. Using the colloidal silica dispersion according to the invention, the silica particles can be evenly dispersed in the electrolyte. The evaporated product of the dispersion is preferably essentially consisting of nano-sized silica. Typically, the evaporated product of the dispersion is an evaporated product of a colloidal silica dispersion that comprises one or more non-polymerizable volatile organic solvents. In such case, when the non-polymerizable volatile organic solvents are evaporated, only silica is left in the evaporated product.

In the invention, the amount of comb-branched polymer (A) is typically from 75 wt. % to 99 wt. %, preferably from 80 wt. % to 95 wt. %, based on the total weight of the material composition.

The amount of the silica particles (B) and component C(polymerizable solvent (C1) or the crosslinker (C2)) in the material composition is preferably in the range of 5 wt. % and 30 wt. %; more preferably 5 wt. %-20 wt. %, based on the weight of the comb-branched polymer.

In the invention, the amount of the polymerizable solvent (C1) or the crosslinker (C2) is typically 1˜50 wt. %; preferably 5˜20 wt. % based on the total weight of the material composition.

The in situ crosslinked solid polymer electrolyte is a comb-branched polymer/silica nanoparticles hybrid polymer electrolyte. Such hybrid polymer electrolytes can be used in solid-state lithium metal secondary batteries.

The crosslinker is used only to crosslink the comb-branched polymer. The crosslinker (C2) may be selected from thiols, methacrylates or acrylates. For example, a crosslinker with difunctional thiol. Examples of the crosslinker include thiol-functionalized dimer of ethylene oxide (SH-EO₂-SH), thiol-functionalized heptamer of ethylene oxide (SH-EO₇-SH).

In some embodiments, the material composition comprises:
A) a comb-branched polymer, such as a comb-branched PEO, with pendant functional groups; and
B1) a colloidal silica dispersion comprising or consisting of:
a) surface-modified silica particles; and
b) a polymerizable solvent, which is selected from monomers, oligomers and/or prepolymers convertible to form a copolymer by nonradical or radical reactions with the comb-branched polymer; or
B2) an evaporated product of a colloidal silica dispersion and a crosslinker capable to crosslink the comb-branched polymer, wherein the silica dispersion comprises or consists of surface-modified silica particles and a non-polymerizable volatile organic solvent.

In such cases, the components B) and C) are component B1) or B2).

In some embodiments, the amount of component b) (polymerizable solvent) above is from 20 wt. % to 90 wt. %, preferably from 30 wt. % to 70 wt. %, based on the total weight of the colloidal silica dispersion.

In some embodiments, the colloidal silica dispersion further comprises: c) a polymer, which is preferably polymerizable with the polymerizable solvent of component b).

The polymerizable solvent is preferably versatile.

The present invention further provides a polymer electrolyte precursor composition capable to form a polymer electrolyte, particularly an in situ crosslinked solid polymer electrolyte, which comprises:
I) the material composition of the invention;
II) a lithium salt; and optionally
III) a free radical initiator for polymerization reaction; and optionally
IV) an organic solvent.

The polymer electrolyte precursor composition of the invention may be used to form an in situ crosslinked solid polymer electrolyte in a lithium ion battery, which has improved performance.

The present invention relates to a preparation method of a solid polymer electrolyte, comprising the steps of:
1) casting the polymer electrolyte precursor composition of the invention comprising a free radical initiator (component III) onto an electrode; and
2) polymerizing in-situ the polymer electrolyte precursor composition by heating or irradiation.

The irradiation is typically UV irradiation.

The present invention further provides a method to in-situ prepare a solid polymer electrolyte lithium ion battery, comprising the steps as follows,
1) casting the polymer electrolyte precursor composition of the invention comprising a free radical initiator (component III) onto an electrode;
2) polymerizing in-situ the polymer electrolyte precursor composition by heating; and
3) Assembling the battery.

The method can obtain a lithium ion battery with improved comprehensive performance or improved electrolyte mechanical property and better electro-chemical performance such as conductivity, lithium transference number, initial discharge capacity and cycling stability.

The invention further provides a solid polymer electrolyte, comprising:
a crosslinked product of a polymerizable solvent, which is selected from monomers, oligomers and/or prepolymers or a crosslinker with a comb-branched polymer, such as a comb-branched PEO with pendant functional groups;
hydrophobically surface-modified silica particles, which are dispersed in the crosslinked product; wherein the average particle size of the silica preferably measured by means of small-angle neutron scattering is between 3 and 50 nm, preferably 5-40 nm, more preferably 8-30 nm; and
a lithium salt dispersed in the crosslinked product.

The solid polymer electrolyte of the invention may be used to prepare a lithium ion battery which has improved performance.

The amount of the silica particles in the solid polymer electrolyte is typically from 1 to 30 wt. %, preferably 3-20 wt. %, more preferably 5-20 wt. %, even more preferably 5-15 wt. % based on the weight of the comb-branched polymer.

In some embodiments, the amount of the silica particles in the solid polymer electrolyte is from 1 to 19 wt. %, preferably 2-14 wt. %, more preferably 5-14 wt. %, even more preferably 5-12 wt. % based on the weight of the solid polymer electrolyte.

In the invention, the silica particles are evenly dispersed in the electrolyte.

The present invention further provides an electrochemical device comprising the solid polymer electrolyte according to the present invention.

In some examples, the electrochemical device is a secondary battery, e.g. a lithium-ion battery, especially a lithium metal secondary battery.

The invention further provides a device, comprising the electrochemical device according to the invention. The device includes but not limited to, electric vehicles, electric home appliances, electric tools, portable communication devices such as mobile phones, consumer electronic products, and any other products that are suitable to incorporate the electrochemical device or lithium ion battery of the invention as an energy source.

### Comb-Branched Polymer

The comb-branched polymer with pendant functional groups may be e.g. a comb-branched polyether, such as comb-branched poly(ethylene oxide) (PEO^{B}) with the pendant functional groups. The comb-branched polymer is preferably liquid at room temperature.

The pendant functional groups can be selected from unsaturated groups, e.g. vinyl groups, alkynyl groups, methacrylate groups. Vinyl groups include —CH═CH₂, and any compound containing that group, namely R—CH═CH₂ where R is any other group of atoms such as allyl groups, or acrylate groups. Such pendant functional groups are distributed along the polymer main chain.

Typically, the polymerizable solvent has multifunctional double bonds capable to copolymerize with the unsaturated bond of the comb-branched polymer.

The comb-branched polymer has more than two cross-linkable functional groups, such as allyl group, locating at the terminals of the backbone and/or the side chains.

The unsaturated groups could react with the polymerizable solvent or the crosslinker.

In some embodiments, the comb-branched PEO may be represented by the following general formula (I):

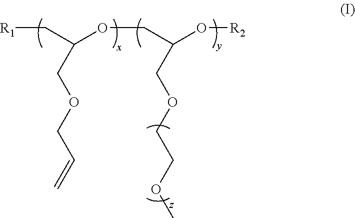

wherein x is an integer in range of 0˜1000, preferably 2-200, more preferably 4-20; y is an integer in range of 1˜1000, preferably 2-200, more preferably 10-100; z is an integer in range of 1-10, preferably 1-6, more preferably 2-4;

R₁ and R₂ each independently represents a vinyl containing functional group or a saturated group, provided that there are more than two unsaturated functional groups in the comb-branched PEO.

The vinyl containing functional group may be selected from ethenyl group, propenyl group, methacrylate group or acrylate group.

The saturated group may be selected from alkyl, alkoxy, cycloalkyl or ether.

The unsaturated functional groups in the polymer should be more than two to ensure the formation of crosslinked electrolyte. If both of R1 and R2 represent the vinyl containing functional groups, x could be 0 or higher; if one of R1 or R2 represents the vinyl group, x should be higher than 1; if R1 and R2 are saturated groups, the x should be higher than 2.

In the general formula (I), x, y and z each represents repeat unit numbers. The molecular weight (MW) of the polymer is in the range of 5-10000 kg/mol, preferably 10-1000 kg/mol, more preferably 10-100 kg/mol.

PEO^{B} with similar chemical structures may also be used in the invention. For example, those disclosed in the prior literatures like ACS Applied Energy Materials, 2018, 1: 6769-6773; and Soft Matter, 2020, 16, 1979-1988, which are incorporated herein in their entirety by reference.

The comb-branched PEO (PEO^{B}) matrix with vinyl functional groups may be synthesized by anionic ring opening polymerization. In some embodiments, a general synthetic route of the PEO^{B} polymer is as follows,

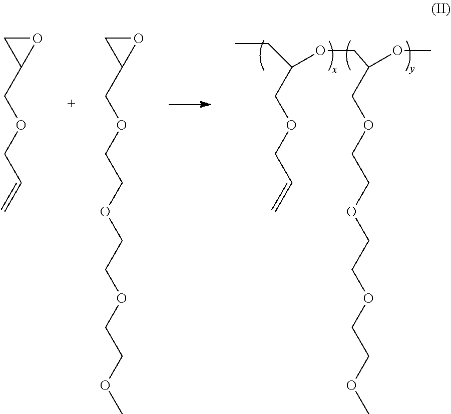

The comb-branched PEOs are made from two kinds of monomer, allyl glycidyl ether (V monomer) and triethylene glycol methyl glycidyl ether (E monomer) with different proportions (V_{X}E_{y}, e.g. V₈E₅₆ means x=8 and y=56 in one polymer chain). The synthesis was carried out according to anionic ring opening polymerization, and the well-defined products have high purity and low distribution index (PDI=1.05).

The monomers useable to prepare the comb-branched PEO polymer of the solid polymer electrolyte of the invention include those known in the art. For example, the monomers mentioned in Wei, W.; Xu, Z. X.; Xu, L.; Zhang, X. L., Xiong, H. M., Yang, J. ACS Appl. Energy Mater. 2018, 1, 6769-6773, which is incorporated herein in its entirety by reference.

In some embodiments, epoxy molecules with pendant allyl group may be used as V monomers.

The comb-branched PEO (PEO^{B}) of the invention includes the EO side chains and reactive allyl groups, which can be further crosslinked and form an elastomer.

### Surface-Modified Silica Particles and Colloidal Silica Dispersion

The silica of the invention is preferably nano-sized silica, which has an average particle size between 1 and 100 nm. The average particle size of the silica typically is between 3 and 50 nm, preferably 5-40 nm, more preferably 8-30 nm. The average particle size of the silica is preferably measured by means of small-angle neutron scattering (SANS).

Typically, the average particle size of the silica as measured by means of small-angle neutron scattering (SANS) is between 3 and 50 nm, preferably 5-40 nm, more preferably 8-30 nm, and wherein the colloidal silica is organically surface modified, especially by silane.

In some embodiments, the average particle size of the silica as measured by means of small-angle neutron scattering (SANS) is between 3 and 50 nm, preferably 5-40 nm, more preferably 8-30 nm, e.g. at a maximum half-width of the distribution curve of 1.5 dₘₐₓ.

In some embodiments, the average particle size dₘₐₓ of the silica nanoparticles is between 6 and 100 nm, preferably 6 and 40 nm, more preferably 8 and 30 nm, more preferably 10 and 25 nm.

In some embodiments, the maximum width at half peak height of the distribution curve of the particle size of the silica nanoparticles is not more than 1.5 d max, preferably not more than 1.2 d max, more preferably not more than 0.75 d max.

In some embodiments, the silica particles are substantially spherical. Preferably the particles have a spherical shape.

In some embodiments, the colloidal silica dispersion is the silica dispersion according to WO 02/083776A1, which is incorporated herein in its entirety by reference.

In some embodiments, the silica dispersion comprises:
aa) an external fluid phase comprising
   aa1) polymerizable monomers, oligomers and/or prepolymers convertible to polymers by nonradical reactions, and/or
   aa2) polymers,
bb) a disperse phase comprising silica, and the average particle size of the silica as measured by means of small-angle neutron scattering (SANS) is between 3 and 50 nm at a maximum half-width of the distribution curve of 1.5dₘₐₓ.

The external fluid phase may comprise a polymer or two or more polymers.

Polymers in this sense are macromolecules which are no longer reactive and which therefore do not react to form larger polymer units.

The fraction of the external phase as a proportion of the dispersion can in the context of the invention be between 20 and 90% by weight, preferably from 30 to 80% by weight, more preferably from 40 to 70% by weight. In some embodiments, said external fluid phase is from 30 to 70% by weight of said dispersion.

In some embodiments, said external fluid phase comprises at least one substance selected from the group consisting of polyols, polyamines, linear or branched polyglycol ethers, polyesters, and polylactones.

In some embodiments, said external fluid phase comprises at least one reactive resin.

In some embodiments, one or more of said polymerizable monomers, oligomers, or prepolymers comprise main chains, and wherein said main chains comprise one or more C, O, N or S atoms.

In the polymerizable solvent of the invention, prepolymers are relatively small polymer units which are able to crosslink and/or polymerize to form larger polymers. “Polymerizable” means that in the composition, especially the external phase there are still polymerizable and/or crosslinkable groups which are able to enter into a polymerization reaction and/or crosslinking reaction in the course of further processing of the dispersion. In some embodiments, the external phase comprises polymerizable constituents which are convertible to polymers by non-radical reactions. This means that the polymerization to polymers does not proceed by way of a free-radical mechanism. Preference is given instead of this to polycondensations (polymerization occurring in stages with the elimination of secondary products) or polyadditions (polymerizations proceeding in stages without elimination of secondary products). Likewise provided by the invention are anionic or cationic polymerizable constituents in the external phase. In some embodiments, the dispersion does not have an external phase which comprises polymerizable acrylates or methacrylates as a substantial constituent. In some embodiments, the dispersion has an external phase which comprises polymerizable acrylates or methacrylates as a substantial constituent.

Polymerizable acrylates or methacrylates are all monomeric, oligomeric or prepolymeric acrylates or methacrylates which in the course of the production of a material from the dispersion are deliberately subjected to a further polymerization.

One example of the polyadditions is the synthesis of polyurethanes from diols and isocyanates, one example of polycondensations is the reaction of dicarboxylic acids with diols to form polyesters.

As external phase, furthermore, it is also possible in accordance with the invention to use monomers and oligomers. These include in particular those monomeric or oligomeric compounds which can be reacted to form polymers by polyaddition or polycondensation.

In one preferred embodiment of the invention the polymerizable monomers, oligomers and/or prepolymers contain carbon, oxygen, nitrogen and/or sulfur atoms in the main chain. The polymers are therefore organic hydrocarbon polymers (with or without heteroatoms); polysiloxanes do not come under this preferred embodiment. The external fluid phase may preferably comprise polymerizable monomers without radically polymerizable double bonds and also reactive resins.

In some embodiments, the polymerizable solvent is selected from polymerizable acrylates or methacrylates.

In some embodiments, the polymerizable solvent is selected from acrylates, or functional acrylates.

Examples of polymerizable solvent include but are not limited to: functional acrylates, including:
monofunctional acrylate monomer such as hydroxyethylmethylacrylate (HEMA), cyclic trimethylolpropane formal acrylate (CTFA),
difunctional acrylate monomer such as tripropyleneglycoldiacrylate (TPGDA), hexanedioldiacrylate (HDDA),
trifunctional polyether acrylate monomer such as trimethylolpropane ethoxylate triacrylate (ETPTA), trimethylolpropanetriacrylate (TMPTA), and
tetrafunctional polyether acrylate monomer such as alkoxylated (4) pentaerythritol tetraacrylate (PPTTA).

Examples of non-polymerizable volatile organic solvent include but are not limited to ester solvents including acetate solvents such as n-butyl acetate and 1-methoxy-2-propanol acetate.

Examples of the colloidal silica dispersion comprising a polymerizable solvent according to the invention include any one of the following products:
Nanocryl® A 223, which is a versatile dispersion of colloidal silica in a trifunctional polyether acrylate typically for the use in adhesive applications. The silica phase consists of surface-modified, synthetic SiO₂-spheres of very small size (Ø 20 nm) and narrow particle size distribution. Despite the high SiO₂-content of 50 wt. %,
Nanocryl A 223 is highly transparent, low viscous and shows no sedimentation due to the agglomerate-free dispersion of the nanoparticles in the acrylate. The trifunctional polyether acrylate above is trimethylolpropane ethoxylate triacrylate (ETPTA, average Mn-428).
Nanocryl® A 235, which is a versatile dispersion of colloidal silica in a tetrafunctional polyether acrylate typically for the use in adhesive and electronic applications. The silica phase consists of surface-modified, synthetic SiO₂-spheres of very small size (Ø 20 nm) and narrow particle size distribution. Despite the high SiO₂-content of 50 wt. %, NANOCRYL® A 235 is highly transparent, low viscous and shows no sedimentation due to the agglomerate-free dispersion of the nanoparticles in the acrylate. The tetrafunctional polyether acrylate above is alkoxylated (4) pentaerythritol tetraacrylate (PPTTA, average Mn-528).
NANOCRYL® A 200, which is a versatile dispersion of colloidal silica in a monofunctional acrylate monomer for the use in adhesive applications. The monofunctional acrylate monomer is cyclic trimethylolpropane formal acrylate (CTFA, CAS No: 66492-51-1).
NANOCRYL® A 210, which is a versatile dispersion of colloidal silica in a difunctional acrylate monomer for the use in adhesive and electronic applications. The dispersion comprises high SiO₂ content of 50 wt. %. The difunctional acrylate monomer is hexanedioldiacrylate (HDDA).
NANOCRYL® A 215, which is a versatile dispersion of colloidal silica in a difunctional acrylate monomer for the use in adhesive applications. The dispersion comprises high SiO₂ content of 50 wt. %. The difunctional acrylate monomer is tripropyleneglycoldiacrylate (TPGDA).
NANOCRYL® A 220, which is a versatile dispersion of colloidal silica in a trifunctional acrylate monomer for the use in adhesive applications. The dispersion comprises high SiO₂ content of 50 wt. %. The trifunctional acrylate monomer is trimethylolpropanetriacrylate (TMPTA).
NANOCRYL® A 370, which is a versatile dispersion of colloidal silica in a monofunctional acrylate monomer. The dispersion comprises high SiO₂ content of 50 wt. %. The monofunctional acrylate monomer is hydroxyethylmethylacrylate (HEMA).

Examples of the evaporated products of a colloidal silica dispersion comprising a non-polymerizable volatile organic solvent include any one of the following:
Evaporated Nanopol® A 720 without solvent. Nanopol® A 720 is a versatile dispersion of colloidal silica in n-butyl acetate solvent. The silica phase consists of surface-modified, synthetic SiO₂-spheres of very small size (Ø 20 nm) and narrow particle size distribution. Despite the high SiO₂-content of 50 wt. %, Nanopol® A 720 is highly transparent, low viscous and shows no sedimentation due to the agglomerate-free dispersion of the nanoparticles in the solvent. In the invention, the solvent n-butyl acetate of Nanopol® A 720 is evaporated (e.g. by heating at 80° C. under vacuum for 48 h). The evaporated Nanopol® A 720 without solvent is used as the main component of the material composition of the invention, as organic solvent is undesirable in the solid polymer electrolyte of the invention.
Evaporated Nanopol® A 710 without solvent. Nanopol® A 710 is a versatile dispersion of colloidal silica in 1-methoxy-2-propanol acetate solvent. The dispersion comprises high SiO₂ content of 50 wt. %.

The above Nanocryl® and Nanopol® series products are also known as “nano resins” (hereinafter “NR”) and are all commercially available from Evonik Industries 40 AG.

### Free Radical Initiator

The free radical initiator of the polymerization reaction is for the thermal- or photo-polymerization reaction of the reactive monomers, and may be those conventional 45 in the art.

Examples of free radical initiator or the polymerization initiator may include azo compounds such as 2,2-azobis(2-cyanobutane), 2,2-azobis(methylbutyronitrile), 2,2′-azoisobutyronitrile (AIBN), azobisdimethyl-valeronitrile (AMVN) and the like, peroxy compounds such as benzoyl peroxide, acetyl peroxide, dilauryl peroxide, di-tert-butyl peroxide, cumyl peroxide, hydrogen peroxide and the like, and hydroperoxides. Preferably, AIBN, 2,2′-azobis(2,4-dimethyl valeronitrile) (V65), Di-(4-tert-butylcyclohexyl)-peroxydicarbonate (DBC), or the like may also be employed.

Preferably the free radical initiator may be selected from azobisisobutyronitrile (AIBN), azobisisoheptanenitrile (ABVN), benzoyl peroxide (BPO), lauroyl peroxide (LPO) and so on. More preferably, the free radical initiator is azobisisobutyronitrile (AIBN).

The free radical photoinitiators produce free radicals when exposed to UV light, then setup the polymerization. Examples of photoinitiators may include benzoyl compounds such as 2,2-dimethoxy-1,2-diphenyl-ethan-1-one (DMPA), Benzil Dimethyl Ketal, diphenyl(2,4,6-trimethylbenzoyl)phosphine oxide (TPO), 2-hydroxy-2-methyl propiophenone (HMPP), 1-hydroxycyclohexyl phenyl ketone (HCPK), and the like may also be employed.

Preferably the free radical photoinitiator may be selected from 2,2-dimethoxy-1,2-diphenyl-ethan-1-one (DMPA), Benzil Dimethyl Ketal, diphenyl(2,4,6-trimethylbenzoyl)phosphine oxide (TPO) and so on. More preferably, the free radical photoinitiator is 2,2-dimethoxy-1,2-diphenyl-ethan-1-one (DMPA).

The amount of the free radical initiator is conventional. Preferably the amount of the free radical initiator is 0.1-3 wt. %, more preferably around 0.5 wt. % based on the total weight of the comb-branched PEO.

In some embodiments, the polymerization initiator is decomposed at a certain temperature of 40 to 80° C. to form radicals, and may react with monomers via the free radical polymerization to form a polymer electrolyte. Generally, the free radical polymerization is carried out by sequential reactions consisting of the initiation involving formation of transient molecules having high reactivity or active sites, the propagation involving re-formation of active sites at the ends of chains by addition of monomers to active chain ends, the chain transfer involving transfer of the active sites to other molecules, and the termination involving destruction of active chain centers.

### Lithium Salt

The lithium salt is a material that is dissolved in the non-aqueous electrolyte to thereby resulting in dissociation of lithium ions.

The lithium salt may be those used conventional in the art but is thermally stable during in-situ polymerization (e.g. at 80° C.), non-limiting examples may be at least one selected from lithium bis(fluorosulfonyl) imide(LiFSI), lithium bis(trifluoromethanesulfonyl)imide (LiTFSI), lithium difluorooxalate borate (LiODFB), LiAsF₆, LiClO₄, LiN(CF₃SO₂)₂, LiBF₄, LiSbF₆, and LiCl, LiBr, Lil, LiB₁₀CI₁₀, LiCF₃SO₃, LiCF₃CO₂, LiAlCl₄, CH₃SO₃Li, CF₃SO₃Li, (CF₃SO₂)₂NLi, chloroborane lithium, lower aliphatic carboxylic acid lithium, lithium tetraphenyl borate and imide. The lithium salt is preferably selected from LiFSI, LiTFSI and LiODFB. These materials may be used alone or in any combination thereof.

The amount of lithium salt is also conventional, for example 5-80 wt. %, most preferably around 40 wt. % based on the total weight of the polymer electrolyte precursor composition.

Additionally, in order to improve charge/discharge characteristics and flame retardancy, for example, pyridine, triethylphosphite, triethanolamine, ethylenediamine, n-glyme, hexaphosphoric triamide, nitrobenzene derivatives, sulfur, quinone imine dyes, N-substituted oxazolidinone, N,N-substituted imidazolidine, ethylene glycol dialkyl ether, ammonium salts, pyrrole, 2-methoxy ethanol, aluminum trichloride or the like may be added to the electrolyte. If necessary, in order to impart incombustibility, the electrolyte may further include halogen-containing solvents such as carbon tetrachloride and ethylene trifluoride.

The electrochemical device encompasses all kinds of devices that undergo electrochemical reactions. Examples of the electrochemical device include all kinds of primary batteries, secondary batteries, fuel cells, solar cells, capacitors and the like, preferably secondary batteries.

The inventive solid-state polymer electrolyte is a polymer electrolyte based on a composite of comb-branched polymer and silica nanoparticles. In some embodiments, the solid-state polymer is also called as PEO^{B}-nano resin hybrid polymer electrolyte, or PEO^{B}-nano resin electrolyte.

There is no free liquid solvent in the inventive solid-state polymer electrolyte such as the PEO^{B}-nano resin (PEO^{B}-NR) hybrid polymer electrolyte. For example, the dispersion liquid (i.e., the polymerizable solvent) in the colloidal silica is e.g. the reactive acrylate-based monomer. Through in-situ heating, the monomers in the silica dispersion reacted with the allyl groups in the PEO polymer and form the crosslinked all-solid-state polymer electrolyte.

The invention provides a method to fabricate the fully amorphous PEO based hybrid all-solid-state ion conducting elastomer. The attached highly mobile EO branches could “solvate” the polymer chain, and result in an intrinsically amorphous system with superior salt solubility and fast Li ion motion. The surface modified colloidal silica shows good compatibility with the comb-branched PEO and can uniformly disperse into the polymer matrix. Through the in-situ heating, the dispersion liquid (i.e., the polymerizable solvent) in the silica dispersion or the crosslinker can react with the polymer matrix to form the mechanically stable crosslinked elastomer. By adjusting the composition of the material composition and the structure of the elastomer, the electrochemical performance and mechanical property of the solid electrolyte could be optimized.

The traditional linear PEO is semi-crystalline materials that suffers from the poor electrochemical property (i.e., ionic conductivity, transference number, and electrochemical window). The comb-branched PEO in the invention is a fully amorphous polymer. On the other hand, the traditional silica possesses large particle size, and usually shows poor incompatibility with PEO and may from aggregates in the matrix. Surprisingly, the polymerizable solvent or crosslinker of the material composition of the invention crosslinks with the comb-branched PEO polymer matrix to form a SPE with improved mechanical property and better electro-chemical performance.

In this invention, the colloidal surface modified silica nanoparticles show good compatibility with the comb-branched polymer and can uniformly dispersed in the polymer matrix to form a crosslinked comb-branched polymer/silica nanoparticles (such as PEO^{B}-NR) composite. By in-situ crosslinking of the comb-branched polymer/silica nanoparticles (e.g. PEO^{B}-NR) composite, the comprehensive performance or the mechanical property, ionic conductivity, lithium transference number and cycling stability of the lithium ion batteries could be simultaneously improved compared with traditional PEO-based electrolytes and comb-branched PEO matrix without colloidal silica, which can eventually lead to the stable and superior battery performance.

Other advantages of the present invention would be apparent for a person skilled in the art upon reading the specification.

### BRIEF DESCRIPTION OF DRAWINGS

FIG. 1 shows the temperature-dependent Electrochemical Impedance Spectroscopy (EIS) profiles of PEO^{B}-NR with 10 wt. % Nanocryl® A 235 hybrid polymer electrolytes of Example 1b.

FIG. 2 shows the ionic conductivities of PEO^{B}-NR with various percentage of Nanocryl® A 235 of Examples 1a-1d and Comparative Example 1a.

FIG. 3 shows the comparation of the ionic conductivities of the PEO^{B} electrolytes of Comparative Example 1a, the PEO^{B}-A235 hybrid polymer electrolytes of Examples 1b and 1d, and the PEO^{B}-POSS electrolytes of Comparative Examples 2a and 2b.

FIG. 4 shows the conductivity of PEO^{B}-NR hybrid polymer electrolytes with different NR and POSS prepared in Examples 1a-1d,1v,1w, Examples 2a-2d, Examples 3a-3d and Comparative Examples 2a and 2b.

FIG. 5 shows the current-time (i-t) and EIS profiles of the PEO^{B}-A235 10 wt. % of Example 1e before and after polarization.

FIG. 6 shows the mechanical properties measured by dynamic mechanical analysis (DMA) for PEO^{B}-A235 hybrid elastomers of Example 4a, Example 4b and PEO^{B} elastomer of Comparative Example 3.

FIG. 7 shows the Li/SPE/Li cycling performance of the linear PEO electrolyte of Comparative Example 4, PEO^{B} Nanocryl® A 235 SPE of Example 1e, and PEO^{B}SPE of Comparative Example 1 b at ambient temperature and current density of 0.3 mA cm⁻².

FIG. 8 shows the cycling performance (discharge capacity) of the PEO^{B}-10 wt. % Nanocryl® A 235 electrolyte of Example 1g, PEO^{B}-10 wt. %-POSS electrolyte of Comparative Example 2e and PEO^{B} based SPE of Comparative Example 1c at 0.2 C rate.

FIG. 9 shows the discharge capacity and coulombic efficiency of the PEO^{B}-10 wt. % A235 electrolyte of Example 1g at 0.2 C rate.

FIG. 10 shows the charge/discharge profiles of the PEO^{B}-10 wt. % A235 electrolyte of Example 1g at 0.2 C rate.

FIG. 11 shows the discharge capacity and coulombic efficiency of the electrolyte of PEO^{B} based SPE of Comparative Example 1c at 0.2 C rate.

### DETAILED DESCRIPTION OF THE INVENTION

The invention is now described in detail by the following examples. The scope of the invention should not be limited to the embodiments of the examples.

In the examples, the lithium metal batteries were prepared according to the following method:
Step a) preparation of electrolyte precursor composition solution;
Step b) solvent cast of the solution on the electrodes and in-situ crosslinked by heating; and
Step c) assembly of a lithium metal battery; wherein Step a) and b) were performed in a glove box filled with argon gas (H₂O, O₂ s 0.5 ppm).

Unless otherwise specified, the cathode was fabricated by applying a mixture of a LiFePO₄ (LFP) cathode active material, conductive acetylene black and a PVDF binder to a cathode current collector, followed by drying and pressing.

In the following examples, the weight percentage of nano resin refers to the weight percentage of silica particles based on the weight of the comb-branched polymer.

Example 1 (PEO^{B}-A235 electrolyte) Example 1a: (SS-SS)

### 1) Preparation of PEO^{B}-5 wt. % A235 electrolyte

To prepare the PEO^{B}-5 wt. % A235, 20 mg PEO^{B} prepared in Comparative Example 1a below, 2 mg Nanocryl® A 235 (“A235”) (50 wt. % colloidal silica and 50 wt. % PPTTA), 10 mg LiTFSI and 0.2 mg AIBN were dissolved in dry THF. The solution was evenly drop-casted onto a stainless-steel (SS) disk and then heated up to 80° C.

The fully crosslinked film formed after approximately 20 min. The film was then dried under vacuum for around 1 hour to remove the trace amount of solvent.

### 2) Preparation of SS-SS cell

The SS disk, the SPE thin film, a second SS disk and a leaf spring were stacked in the 2032 type coin cell shell, and the cell was sealed under pressure.

### Example 1b: (SS-SS)

### 1) Preparation of PEO^{B}-10 wt. % A235 electrolyte

To prepare the PEO^{B}-10 wt. % A235, 20 mg PEO^{B} prepared in Comparative Example 1a below, 4 mg Nanocryl® A 235, 10 mg LiTFSI and 0.2 mg AIBN were dissolved in dry THF. The solution was evenly drop-casted onto a stainless-steel (SS) disk and then heated up to 80° C. The fully crosslinked film formed after approximately 20 min. The film was then dried under vacuum for around 1 hour to remove the trace amount of solvent.

### 2) Preparation of SS-SS cell

The SS disk, the SPE thin film, a second SS disk and a leaf spring were stacked in the 2032 type of coin cell shell, and the cell was sealed under pressure.

### Example iv: (SS-SS)

### 1) Preparation of PEO^{B}-12 wt. % A235 electrolyte

To prepare the PEO^{B}-12 wt. % A235, 20 mg PEO^{B} prepared in Comparative Example 1a below, 4.8 mg Nanocryl® A 235, 10 mg LiTFSI and 0.2 mg AIBN were dissolved in dry THF. The solution was evenly drop-casted onto a stainless-steel (SS) disk and then heated up to 80° C. The fully crosslinked film formed after approximately 20 min. The film was then dried under vacuum for around 1 hour to remove the trace amount of solvent.

### 2) Preparation of SS-SS cell

The SS disk, the SPE thin film, a second SS disk and a leaf spring were stacked in the 2032 type of coin cell shell, and the cell was sealed under pressure.

### Example 1w: (SS-SS)

### 1) Preparation of PEO^{B}-13 wt. % A235 electrolyte

To prepare the PEO^{B}-13 wt. % A235, 20 mg PEO^{B} prepared in Comparative Example 1a below, 5.2 mg Nanocryl® A 235, 10 mg LiTFSI and 0.2 mg AIBN were dissolved in dry THF. The solution was evenly drop-casted onto a stainless-steel (SS) disk and then heated up to 80° C. The fully crosslinked film formed after approximately 20 min. The film was then dried under vacuum for around 1 hour to remove the trace amount of solvent.

### 2) Preparation of SS-SS cell

The SS disk, the SPE thin film, a second SS disk and a leaf spring were stacked in the 2032 type of coin cell shell, and the cell was sealed under pressure.

### Example 1c: (SS-SS)

### 1) Preparation of PEO^{B}-15 wt. % A235 electrolyte

To prepare the PEO^{B}-15 wt. % A235, 20 mg PEO^{B} prepared in Comparative Example 1a below, 6 mg Nanocryl® A 235, 10 mg LiTFSI and 0.2 mg AIBN were dissolved in dry THF. The solution was evenly drop-casted onto a stainless-steel (SS) disk and then heated up to 80° C. The fully crosslinked film formed after approximately 20 min. The film was then dried under vacuum for around 1 hour to remove the trace amount of solvent.

### 2) Preparation of SS-SS cell

The SS disk, the SPE thin film, a second SS disk and a leaf spring were stacked in the 2032 type of coin cell shell, and the cell was sealed under pressure.

### Example 1d: (SS-SS)

### 1) Preparation of PEO^{B}-20 wt. % A235 electrolyte

To prepare the PEO^{B}-20 wt. % A235, 20 mg PEO^{B} prepared in Comparative Example 1a below, 8 mg Nanocryl® A 235, 10 mg LiTFSI and 0.2 mg AIBN were dissolved in dry THF. The solution was evenly drop-casted onto a stainless-steel (SS) disk and then heated up to 80° C. The fully crosslinked film formed after approximately 20 min. The film was then dried under vacuum for around 1 hour to remove the trace amount of solvent.

### 2) Preparation of SS-SS cell

The SS disk, the SPE thin film, a second SS disk and a leaf spring were stacked in the 2032 type of coin cell shell, and the cell was sealed under pressure.

### Example 1e: (Li—Li)

### 1) Preparation of PEO^{B}-10 wt. % A235 electrolyte

To prepare the PEO^{B}-10 wt. % A235, 20 mg PEO^{B} prepared in Comparative Example 1a, 4 mg Nanocryl*A 235, 10 mg LiTFSI and 0.2 mg AIBN were dissolved in dry THF. The solution was evenly drop-casted onto a lithium plate and then heated up to 80° C. The fully crosslinked film formed after approximately 20 min. The film was then dried under vacuum for around 1 hour to remove the trace amount of solvent.

### 2) Preparation of Li—Li cell

The lithium plate, the SPE thin film, a second lithium plate, a steel disc and a leaf spring were stacked in the 2032 type of coin cell shell, and the cell was sealed under pressure.

### Example 1f: (Li—Li)

### 1) Preparation of PEO^{B}-20 wt. % A235 electrolyte

To prepare the PEO^{B}-20 wt. % A235, 20 mg PEO^{B} prepared in Comparative Example 1a, 8 mg Nanocryl*A 235, 10 mg LiTFSI and 0.2 mg AIBN were dissolved in dry THF. The solution was evenly drop-casted onto a lithium plate and then heated up to 80° C. The fully crosslinked film formed after approximately 20 min. The film was then dried under vacuum for around 1 hour to remove the trace amount of solvent.

### 2) Preparation of Li—Li cell

The lithium plate, the SPE thin film, a second lithium plate, a steel disc and a leaf spring were stacked in the 2032 type of coin cell shell, and the cell was sealed under pressure.

### Example 1: (Li-LFP)

### 1) Preparation of PEO^{B}-10 wt. % A235 electrolyte

In-situ polymerization by heating was conducted according to the same method as Example 1e.

### 2) Preparation of Li-LFP cell

A LFP cathode was prepared as follows: A composition of 67/20/10/3 (wt. %) of LFP, PEG 400, acetylene black, and the PVDF binder were mixed in N-methylpyrrolidone (NMP) solvent, casted on aluminum foil and dried in a vacuum at 110° C. overnight. The active material loading is 2 mg/cm². To assemble the Li-LFP cell, the lithium plate, the SPE thin film, a LFP cathode, a steel disc and a leaf spring were stacked in the 2032 type coin cell shell, and the cell was sealed under pressure. The thickness of the cathode and solid electrolyte was approximately 30 and 50 μm, respectively.

### Example 2 (PEO^{B}-A223 electrolyte) Example 2a: (SS-SS)

### 1) Preparation of PEO^{B}-5 wt. % A223 electrolyte

A PEO^{B}-5 wt. % A223 electrolyte was prepared according to a method same as that of Example 1a, except that Nanocryl® A 223 (“A223”) (50 wt. % colloidal silica and 50 wt. % ETPTA) was used instead of Nanocryl*A 235. A solid PEO^{B}-10 wt. % A223 electrolyte was prepared.

### 2) Preparation of SS-SS cell

The SS/SS coin-cell batteries (2032 type) were assembled through a lamination process as described in Example 1a.

### Example 2b: (SS-SS)

### 1) Preparation of PEO^{B}-10 wt. % A223 electrolyte

A PEO^{B}-10 wt. % A223 electrolyte was prepared according to a method same as that of Example 1b, except that Nanocryl® A 223 was used instead of Nanocryl® A 235. A solid PEO^{B}-10 wt. % A223 electrolyte was prepared.

### 2) Preparation of SS-SS cell

The SS/SS coin-cell batteries (2032 type) were assembled through a lamination process as described in Example 1 b.

### Example 2c: (SS-SS)

### 1) Preparation of PEO^{B}-15 wt. % A223 electrolyte

A PEO^{B}-15 wt. % A223 electrolyte was prepared according to a method same as that of Example 1c, except that Nanocryl® A 223 was used instead of Nanocryl® A 235. A solid PEO^{B}-15 wt. % A223 electrolyte was prepared.

### 2) Preparation of SS-SS cell

The SS/SS coin-cell batteries (2032 type) were assembled through a lamination process as described in Example 1c.

### Example 2d: (SS-SS)

### 1) Preparation of PEO^{B}-20 wt. % A223 electrolyte

A PEO^{B}-20 wt. % A223 electrolyte was prepared according to a method same as that of Example 1d, except that Nanocryl® A 223 was used instead of Nanocryl® A 235. A solid PEO^{B}-20 wt. % A223 electrolyte was prepared.

### 2) Preparation of SS-SS cell

The SS/SS coin-cell batteries (2032 type) were assembled through a lamination process as described in Example 1d.

### Example 3 (PEO^{B}-A 720 electrolyte)

### Example 3a: (SS-SS)

### 1) PEO^{B}-5 wt. % Nanopol® A 720 electrolyte

To prepare the PEO^{B}-A720 hybrid SPE, 20 mg PEO^{B}, 0.45 mg thiol-functionalized dimer of ethylene oxide (SH-EO₂-SH, commercially available from Shanghai Toyong Bio Tech. Inc., Shanghai, China), 1 mg evaporated Nanopol® A 720 (silica particles after removing the solvent at 80° C. under vacuum for 48h) (“A720”),10 mg LiTFSI and 0.2 mg AIBN were dissolved in dry THF. The solution was evenly drop-casted onto a stainless-steel disk and then heated up to 80° C. The fully crosslinked film formed after approximately 20 min. The film was then dried under vacuum for around 1 hour to remove the trace amount of solvent, and the 2032 type of cell was assembled.

### 2) Preparation of SS-SS cell

The SS/SS coin-cell batteries (2032 type) were assembled through a lamination process similar with the method in Example 1a.

### Example 3b: (SS-SS)

### 1) PEO^{B}-10 wt. % Nanopol® A 720 electrolyte

To prepare the PEO^{B}-A720 hybrid SPE, 20 mg PEO^{B}, 0.45 mg SH-EO₂-SH, 2 mg evaporated A720, 10 mg LiTFSI and 0.2 mg AIBN were dissolved in dry THF. The solution was evenly drop-casted onto a stainless-steel disk and then heated up to 80° C. The fully crosslinked film formed after approximately 20 min. The film was then dried under vacuum for around 1 hour to remove the trace amount of solvent, and the 2032 type of cell was assembled.

### 2) Preparation of SS-SS cell

The SS/SS coin-cell batteries (2032 type) were assembled through a lamination process similar with the method in Example 1b.

### Example 3c: (SS-SS)

### 1) PEO^{B}-15 wt. % Nanopol® A 720 electrolyte

To prepare the PEO^{B}-A720 hybrid SPE, 20 mg PEO^{B}, 0.45 mg SH-EO₂-SH, 3 mg evaporated A720, 10 mg LiTFSI and 0.2 mg AIBN were dissolved in dry THF. The solution was evenly drop-casted onto a stainless-steel disk and then heated up to 80° C. The fully crosslinked film formed after approximately 20 min. The film was then dried under vacuum for around 1 hour to remove the trace amount of solvent, and the 2032 type of cell was assembled.

### 2) Preparation of SS-SS cell

The SS/SS coin-cell batteries (2032 type) were assembled through a lamination process similar with the method in Example 1c.

### Example 3d: (SS-SS)

### 1) PEO^{B}-20 wt. % Nanopol® A 720 electrolyte

To prepare the PEO^{B}-A720 hybrid SPE, 20 mg PEO^{B}, 0.45 mg SH-EO₂-SH, 4 mg evaporated A720, 10 mg LiTFSI and 0.2 mg AIBN were dissolved in dry THF. The solution was evenly drop-casted onto a stainless-steel disk and then heated up to 80° C. The fully crosslinked film formed after approximately 20 min. The film was then dried under vacuum for around 1 hour to remove the trace amount of solvent, and the 2032 type of cell was assembled.

### 2) Preparation of SS-SS cell

The SS/SS coin-cell batteries (2032 type) were assembled through a lamination process similar with the method in Example 1c.

### Example 4a (PEO^{B}-10 wt. % A235 hybrid elastomer)

To prepare the PEO^{B}-10 wt. % A235 hybrid elastomer (without lithium salt) for DMA test, 100 mg PEO^{B}, 20 mg Nanocryl® A 235 and 1 mg AIBN were dissolved in dry THF. The polymer solution was transferred into the PTFE rectangular mold and heated up to 80° C. for 30 min. The film was further dried in a vacuum chamber at 50° C. for 8 hours.

### Example 4b (PEO^{B}-20 wt. % A235 hybrid elastomer)

To prepare the PEO^{B}-20 wt. % A235 hybrid elastomer (without lithium salt) for DMA test, 100 mg PEO^{B}, 40 mg Nanocryl® A 235 and 1 mg AIBN were dissolved in dry THF. The polymer solution was transferred into the PTFE rectangular mold and heated up to 80° C. for 30 min. The film was further dried in a vacuum chamber at 50° C. for 8 hours.

### Comparative Example 1 (PEO^{B}electrolyte)

### Comparative Example 1a: (SS-SS)

1) Preparation of linear PEO^{B} polymer: Allyl glycidyl ether (V monomer) was dried by CaH₂ and then distilled into another flask. triethylene glycol methyl glycidyl ether (E monomer) (1.4 mL, 6.8 mmol) was distilled into the reactor and dried at 50° C. for 2 h, then freeze-thawed for three cycles. Afterwards, the pre-dried V comonomer (0.1 mL, 0.76 mmol) and toluene (1.5 mL) were distilled into the flask. In another reactor, 1,4,7,10,13,16-hexaoxacyclooctadecane (18-Crown-6) (˜1 mg) and potassium tert-butoxide (˜1 M in tetrahydrofuran (THF), 151 μL) were added under a nitrogen atmosphere and THF was then removed. The mixture of the monomer solution was transferred into the above reactor to start the polymerization reaction. The 45 polymerization reaction was kept at 0° C. for 10 days and terminated by MeCOH. The resulting polymer was a transparent, colorless viscous liquid. The produced liquid was analyzed by ¹H NMR and GPC. ¹H NMR (CDCl₃) δ (ppm): 5.7-5.8 (m, 1H), 5.9-6.0 (m, 8H), 5.3-5.4 (m, 16H), 5.1-5.2 (m, 2H), 4.2 (s, 2H), 3.3 (s, 134H), 3.5-3.75 (m, 707H), 1.2 (s, 9H). GPC (THF): Mn=12 kg/mol; Mw/Mn=1.01.

A general synthetic route of the PEO^{B} of Comparative Example 1 is as shown in formula (II) above.

### 2) The In-situ preparation of PEO^{B} based SPE

To prepare a PEO^{B} SPE, 20 mg PEO^{B}, 0.45 mg SH-EO₂-SH, 10 mg LiTFSI and 0.2 mg AIBN were dissolved in dry THF, where an equimolar ratio between the allyl group in V₈E₅₆ and the thiol functional group in SH-EO₂-SH was kept (by tuning the mass of the components that containing the same mole ratio between the SH and allyl group), and the ratio between the EO segment and lithium ion was 20: 1. The solution was evenly drop-casted onto a stainless-steel disk and then heated up to 80° C. A fully crosslinked film formed after approximately 20 min. The film was then dried under vacuum for around 1 hour to remove the trace amount of solvent, and the 2032 type of cell was assembled, as follows,

The SS disk, the SPE thin film, a second SS disk and a leaf spring were stacked in the 2032 type of coin cell shell, and the cell was sealed under pressure.

To confirm the complete coupling reaction of the allyl groups in the copolymer and the cross-linker, the thin film was examined by the FTIR experiment. The characteristic stretching band of the C═C bond (1640 cm¹) in allyl group disappeared, indicating the crosslinked networks were obtained.

### Comparative Example 1b: (Li—Li)

The preparation of PEO^{B} based SPE was prepared as follows, 20 mg PEO^{B}, 0.45 mg SH-EO₂-SH, 10 mg LiTFSI and 0.2 mg AIBN were dissolved in dry THF, where an equimolar ratio between the allyl group in V₈E₅₆ and the thiol functional group in SH-EO₂-SH was kept (by tuning the mass of the components that containing the same mole ratio between the SH and allyl group), and the ratio between the EO segment and lithium ion was 20: 1. The solution was evenly drop-casted onto a lithium plate and then heated up to 80° C. A fully crosslinked film formed after approximately 20 min. The film was then dried under vacuum for around 1 hour to remove the trace amount of solvent.

To prepare the Li—Li cell, the lithium plate, the SPE thin film, a second lithium plate, a steel disc and a leaf spring were stacked in the 2032 type of coin cell shell, and the cell was sealed under pressure.

### Comparative Example 1c: (Li-LFP)

The preparation of PEO^{B} based SPE was prepared as follows, 20 mg PEO^{B}, 0.45 mg SH-EO₂-SH, 10 mg LiTFSI and 0.2 mg AIBN were dissolved in dry THF, where an equimolar ratio between the allyl group in V₈E₅₆ and the thiol functional group in SH-EO₂-SH was kept (by tuning the mass of the components that containing the same mole ratio between the SH and allyl group), and the ratio between the EO segment and lithium ion was 20: 1. The solution was evenly drop-casted onto a lithium plate and then heated up to 80° C. A fully crosslinked film formed after approximately 20 min. The film was then dried under vacuum for around 1 hour to remove the trace amount of solvent.

To assemble the Li-LFP cell, the lithium plate, the SPE thin film, a LFP cathode, a steel disc and a leaf spring were stacked in the 2032 type of coin cell shell, and the cell was sealed under pressure.

### Comparative Example 2 (PEO^{B}-POSS electrolyte)

### Comparative Example 2a: (SS-SS)

To prepare the PEO^{B}-10 wt. %-POSS electrolyte, 20 mg PEO^{B}, 2 mg thiol decorated octafunctional polyhedral oligomeric silsesquioxane (POSS-8SH), 10 mg LiTFSI and 0.2 mg AIBN were dissolved in dry THF. The solution was evenly drop-casted onto a stainless-steel disk and then heated up to 80° C. The fully crosslinked film formed after approximately 20 min. The film was then dried under vacuum for around 1 hour to remove the trace amount of solvent, and the 2032 type of cell was assembled.

### Comparative Example 2b: (SS-SS)

To prepare the PEO^{B}-20 wt. %-POSS electrolyte, 20 mg PEO^{B}, 4 mg POSS-8SH, 10 mg LiTFSI and 0.2 mg AIBN were dissolved in dry THF. The solution was evenly drop-casted onto a stainless-steel disk and then heated up to 80° C. The fully crosslinked film formed after approximately 20 min. The film was then dried under vacuum for around 1 hour to remove the trace amount of solvent, and the 2032 type of cell was assembled.

### Comparative Example 2c: (Li—Li)

To prepare the PEO^{B}-10 wt. %-POSS electrolyte, 20 mg PEO^{B}, 2 mg POSS-8SH, 10 mg LiTFSI and 0.2 mg AIBN were dissolved in dry THF. The solution was evenly drop-casted onto a lithium plate and then heated up to 80° C. The fully crosslinked film formed after approximately 20 min. The film was then dried under vacuum for around 1 hour to remove the trace amount of solvent, and the 2032 type of cell was assembled.

### Comparative Example 2d: (Li—Li)

To prepare the PEO^{B}-10 wt. %-POSS electrolyte, 20 mg PEO^{B}, 4 mg POSS-8SH, 10 mg LiTFSI and 0.2 mg AIBN were dissolved in dry THF. The solution was evenly drop-casted onto a lithium plate and then heated up to 80° C. The fully crosslinked film formed after approximately 20 min. The film was then dried under vacuum for around 1 hour to remove the trace amount of solvent, and the 2032 type of cell was assembled.

### Comparative Example 2e: (Li-LFP)

To prepare the PEO^{B}-10 wt. %-POSS electrolyte, 20 mg PEO^{B}, 2 mg thiol decorated octafunctional polyhedral oligomeric silsesquioxane (POSS-8SH), 10 mg LiTFSI and 0.2 mg AIBN were dissolved in dry THF. The solution was evenly drop-casted onto a lithium plate and then heated up to 80° C. The fully crosslinked film formed after approximately 20 min. The film was then dried under vacuum for around 1 hour to remove the trace amount of solvent. To assemble the Li-LFP cell, the lithium plate, the SPE thin film, a LFP cathode, a steel disc and a leaf spring were stacked in the 2032 type of coin cell shell, and the cell was sealed under pressure.

### Comparative Example 3 (PEO^{B}-SH-EO₂-SH elastomer)

To prepare the PEO^{B} based elastomerfor dynamic mechanical analysis (DMA) test, 100 mg PEO^{B}, 2.25 mg SH-EO₂-SH and 1 mg AIBN were dissolved in dry THF. The polymer solution was transferred into the PTFE rectangular mold and heated up to 80° C. for 30 min. The film was further dried in a vacuum chamber at 50° C. for 8 hours.

### Comparative Example 4 (PEO electrolyte)

To prepare a linear PEO based SPE, 20 mg PEO (Mn=100 kg/mol) and 10 mg LiTFSI were dissolved in hot THF and the solution was casted on the lithium plate. The electrode was heated up to 80° C. for 20 min to remove the trace amount of solvent, and the 2032 type of Li—Li cell was assembled.

### Electrochemical properties of the PEO^{B}-NR hybrid polymer electrolytes

### 1) Ionic conductivity

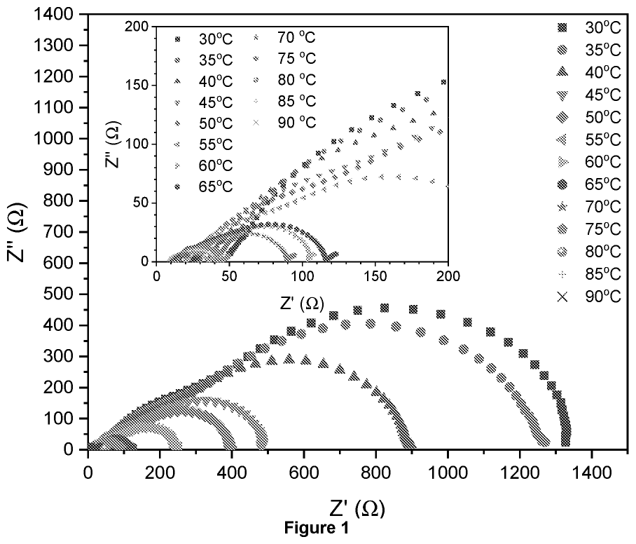

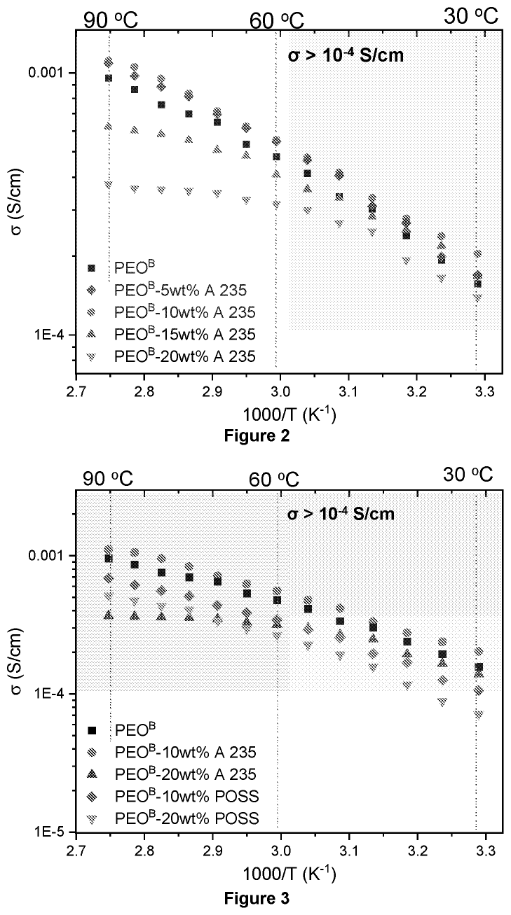

Ionic conductivity was determined based on the electrochemical impedance spectroscopy (EIS) experiments in the frequency range from 100k Hz to 0.1 Hz by using the two-electrode AC impedance method. A cell with two stainless-steel electrodes was employed, and the samples were held at each temperature for more than 15 min to reach the equilibrium state. As shown in FIGS. 1-4, the introduction of Nanocryl® nano resin (Examples 1a-1d, 2a-2d) especially in amount about or less than 10 wt. % based on the weight of the comb-branched polymer obviously increases the ionic conductivity of the electrolyte compared with PEO^{B} electrolyte of Comparative Example 1a (0.16 mS cm⁻¹ without any NR), and the PEO^{B}-10 wt. % A235 hybrid polymer electrolyte of Example 1b possesses the highest ambient ionic conductivity of 0.21 mS cm⁻¹.

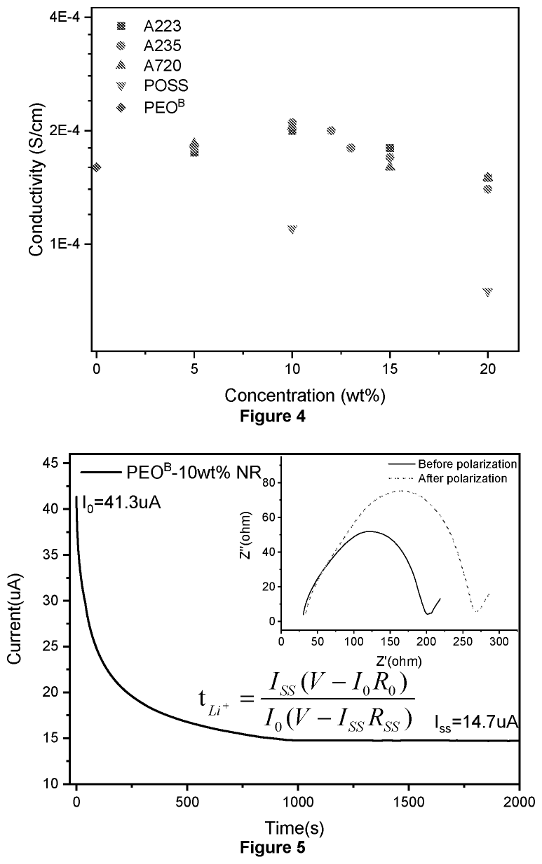

The comparation of ionic conductivity of PEO^{B}-A235 of Example 1b and Example 1d, and PEO^{B}-POSS of Comparative Examples 2a and 2b was manifested in FIG. 3 and FIG. 4. It can be seen that different from the smallest silica nanoparticle POSS, which cannot improve the ionic conductivity, the nano resin is a superior additive and addition of suitable amount of it (e.g. 510 wt. % based on the weight of the comb-branched polymer) leads to the enhancement of ionic conductivity in the SPEs. In addition, the other nano resin Nanocryl® A 223 of Examples 2a-2d and A720 of Examples 3a-3d showed similar effect as A235, and the highest ionic conductivities of the hybrid polymer electrolytes was shown in the sample containing about 10 wt. % of silica particles based on the weight of the comb-branched polymer(Example 1b, 2b and 3b).

### 2) Lithium transference number

The lithium ion transference number (t_{Li+}) of the crosslinked electrolytes was measured, and the results at 30° C. are summarized in FIG. 5 and Table 1. Table 1 shows the lithium ion transference number of PEO^{B}, PEO^{B}-A235 and PEO^{B}_POSS polymer electrolytes. The impedances of the lithium cell were measured before and after the polarization with a DC voltage pulse, ΔV=20 mV. The equation t_{Li+}=I_{SS} (ΔV-I₀R₀)/I₀(ΔV-I_{SS}R_{SS}) was used to calculate the t_{Li+}, where I₀ and I_{SS} are the initial current and current after decaying to a steady state respectively, while R₀ and R_{SS} are the interfacial resistances before and after polarization respectively. FIG. 5 and Table 1 manifest that the additives of A235 in Examples 1e, 1f and POSS in Comparative Example 2c, 2d can both increase the lithium ion transference number for hybrid polymer electrolytes, but A235 has a surprisingly better effect. The lithium ion transference number of PEO^{B} with 20 wt. % A235 is 0.35, which is much higher than PEO^{B} without any NR additives.

TABLE 1

| Example | Sample | σ at 30° C. (S cm⁻¹) | t_{Li+} |
|---|---|---|---|
| Comparative | PEO^{B} | 1.6E−4 | 0.18 |
| Example 1b | | | |
| Example 1e | PEO^{B}-10 wt. % A235 | 2.1E−4 | 0.25 |
| Example 1f | PEO^{B}-20 wt. % A235 | 1.4E−4 | 0.35 |
| Comparative | PEO^{B}-10 wt. % POSS | 1.1E−4 | 0.21 |
| Example 2c | | | |
| Comparative | PEO^{B}-20 wt. % POSS | 7.6E−5 | 0.25 |
| Example 2d | | | |

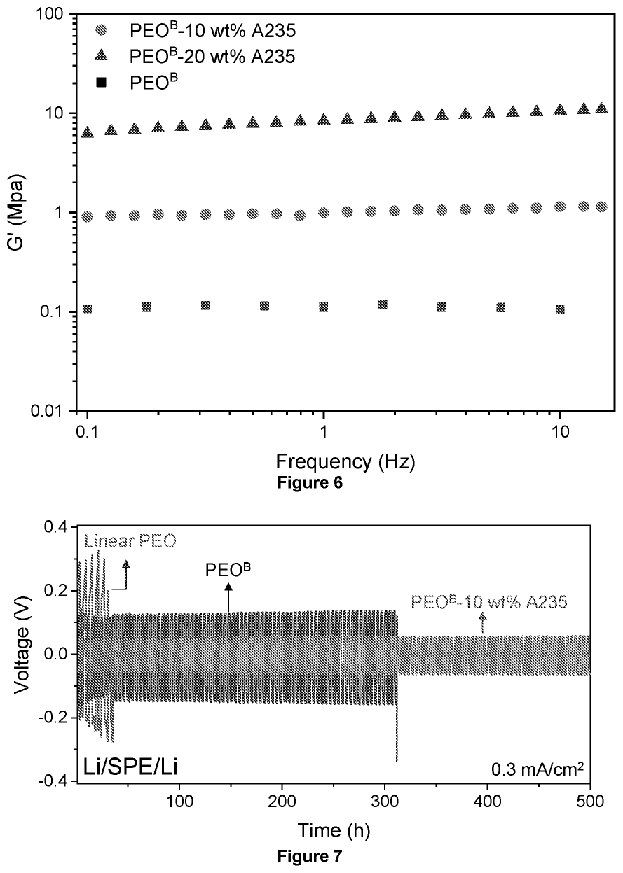

In Example 1f (PEO^{B}-20 wt. % A235), the a is comparable with or slightly lower than Comparative Example 1b (pure PEO^{B}), but the t_{Li+} is nearly 2-fold higher than pure PEO^{B}. The G′ is nearly 2 orders higher than pure PEO^{B}, as shown in FIG. 6. The improvement of comprehensive performance in Example 1f (PEO^{B}-20 wt. % A235) is substantial.

The ionic conductivity in Example 1c (PEO^{B}-15 wt. % A235) is slightly higher than Comparative Example 1b (pure PEO^{B}), the conductivity in Example 1f (PEO^{B}-20 wt. % A235) (1.4E-4 S/cm) is comparable with pure PEO^{B} (1.6E-4 S/cm), as shown in FIG. 4 and Table 1.

### 3) Mechanical properties

The mechanical properties of the samples were determined with a dynamic mechanical thermal analyzer in a tensile mode. The crosslinked polymer films with a dimension of 5 mm×15 mm×0.4 mm were prepared and dried in vacuum overnight. A pre-load force of 0.01 N was used and samples were strained within 15% at a frequency range of 0.1-15 Hz at 30° C. As shown in FIG. 6, the crosslinked elastomers demonstrate stable mechanical property in the wide range of frequency at room temperature. The PEO^{B} based elastomer without NR of Comparative Example 3 shows poor storage modulus of ˜0.1 MPa. The introduction of NR in the hybrid elastomers (Example 4a and Example 4b) shows effective improvement of the mechanical property. The hybrid elastomers with 20 wt. % NR of Example 4b possesses the highest G′ of ˜6 Mpa, which is desirable in the practical application in the battery.

### 4) Cycling performances of the SPEs in Li/Li cell

Galvanostatic cycling measurements were performed on Li/Li symmetric coin cells (2032 type). The contact area between the electrolyte and the lithium foil was 1 cm².

The thickness of the solid electrolytes was about 50 μm. The coin cells were assembled in a glove box. Repeated two-hour charge and discharge cycles were performed for the galvanostatic cycling measurements.

To evaluate the cycling stability in the PEO^{B} system, a long-term cycle study of the symmetric Li/SPE/Li cell was conducted in the linear PEO of Comparative Example 4, PEO^{B} of Comparative Example 1b and PEO^{B}-10 wt. % A235 of Example 1e. As shown in FIG. 7, the Li/PEO^{B}-10 wt. % A235/Li cell cycled stably for more than 500h without any sign of failure. In comparison, the cell using pure PEO^{B} as electrolyte demonstrates the higher voltage and failed after 300h. The linear PEO of Comparative Example 4 could not stable cycles and quickly failed. These results suggest that the introduction of NR in the PEO^{B} system can improve long-term stable cycling, which may due to optimization of both ionic conductivity and mechanical properties.

### 5) The cycling performances of the SPEs in Li/LFP cell

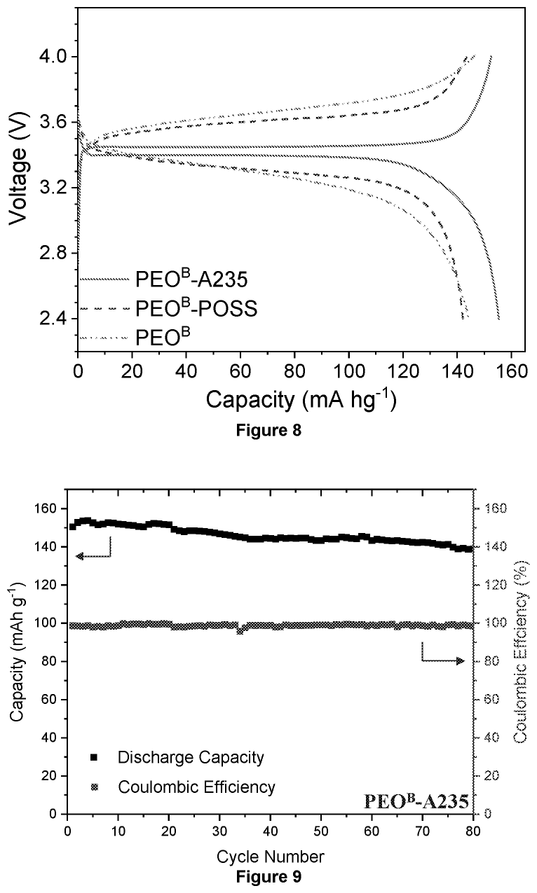

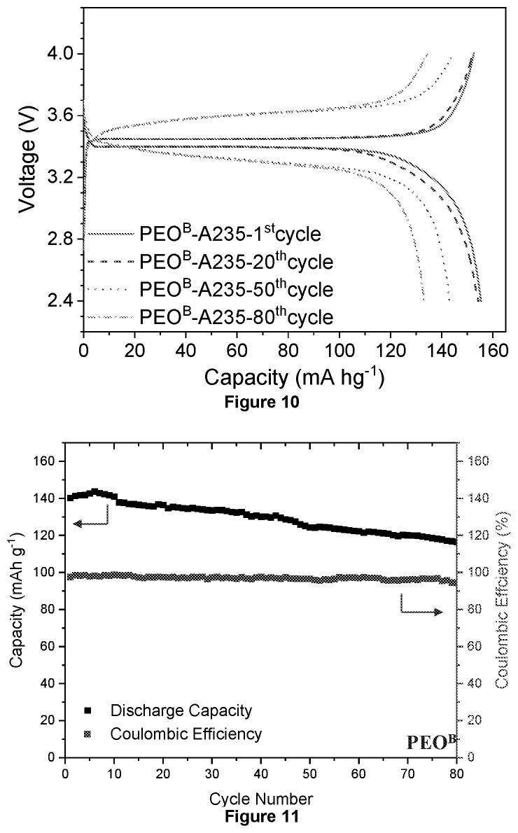

To further evaluate the galvanostatic performance, the PEO^{B} based SPEs of Comparative Example 1c, PEO^{B}-POSS of Comparative Example 2d and PEO^{B}-10 wt. % A235 of Example 1g were employed to assemble Li/SPE/LFP cells. The charge-discharge and cycling performances were evaluated with a cut-off voltage limit of 2.4-4 V, and the cycling rate was set as 0.2 C. Among these samples, cells containing PEO^{B}-10 wt. % A235 of Example 1g delivered the highest initial discharge capacity ˜155 mAh/g at first cycle (see FIG. 8). Notably, the cell shows flat charge/discharge voltage profiles and high initial coulombic efficiency (99%) at 0.2 C (see FIG. 9 and FIG. 10). After 80 cycles, the discharge capacity of the cell maintains 137 mA h g, equivalent to 88% of the initial capacity. In contrast, the pure PEO^{B} generally shows lower discharge capacity than that of the hybrid SPE, which decreases rapidly after cycle for 80 times with capacity retention of 75% (see FIG. 11). The above results indicate the improved electrochemical performance including the high initial discharge capacity and high capacity retention in the NR containing SPEs during the long-term cycles.

As used herein, terms such as “comprise(s)” and the like as used herein are open terms meaning “including at least” unless otherwise specifically noted.

All references, tests, standards, documents, publications, etc. mentioned herein are incorporated herein by reference. Where a numerical limit or range is stated, the endpoints are included. Also, all values and subranges within a numerical limit or range are specifically included as if explicitly written out.

The above description is presented to enable a person skilled in the art to make and use the invention and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown but is to be accorded the widest scope consistent with the principles and features disclosed herein. In this regard, certain embodiments within the invention may not show every benefit of the invention, considered broadly.

1. A material composition to prepare a polymer electrolyte precursor composition capable to form a solid polymer electrolyte, wherein the material composition comprises:
A) a comb-branched polymer with pendant functional groups;
B) surface-modified silica particles; and
C) a polymerizable solvent (C1), which is selected from monomers, oligomers and/or prepolymers convertible to form a copolymer by nonradical or radical reactions with the comb-branched polymer; or
a crosslinker (C2) capable to react with the pendant functional groups in the comb-branched polymer and form a crosslinked material;
wherein the surface-modified silica particles are capable to be dispersed in the polymerizable solvent or a non-polymerizable volatile organic solvent and form a colloidal silica dispersion.

2. The material composition of claim 1, wherein the material composition comprises:
A) a comb-branched polymer with pendant functional groups; and
B1) a colloidal silica dispersion comprising:
a) surface-modified silica particles; and
b) a polymerizable solvent, which is selected from monomers, oligomers and/or prepolymers convertible to form a copolymer by nonradical or radical reactions with the comb-branched polymer;
or
B2) an evaporated product of a colloidal silica dispersion and a crosslinker capable to crosslink the comb-branched polymer, wherein the silica dispersion comprises surface-modified silica particles and a non-polymerizable volatile organic solvent.

3. The material composition of claim 1, wherein the amount of the silica particles (B) is from 1 to 30 wt. % based on the weight of the comb-branched polymer.

4. The material composition of claim 1, wherein the average particle size of the silica is between 3 and 50 nm.

5. The material composition of claim 4, wherein the average particle size of the silica is measured by small-angle neutron scattering.

6. A method for preparing a solid polymer electrolyte in a lithium ion battery, the method comprising: preparing the solid polymer electrolyte with the material composition according to claim 1.

7. A polymer electrolyte precursor composition capable to form a solid polymer electrolyte, comprising:
I) the material composition of claim 1;
II) a lithium salt; and optionally
III) a free radical initiator for polymerization reaction; and optionally
IV) an organic solvent.

8. A preparation method of a solid polymer electrolyte, the method comprising:
1) casting the polymer electrolyte precursor composition of claim 7 comprising a free radical initiator onto an electrode; and
2) polymerizing in-situ the polymer electrolyte precursor composition by heating or irradiation.

9. A method to in-situ prepare a solid polymer electrolyte lithium ion battery, the method comprising:
1) casting the polymer electrolyte precursor composition of claim 7 comprising a free radical initiator onto an electrode;
2) polymerizing in-situ the polymer electrolyte precursor composition; and
3) assembling the battery.

10. A solid polymer electrolyte, comprising:
a crosslinked product of a polymerizable solvent, which is selected from monomers, oligomers and/or prepolymers or a crosslinker with a comb-branched polymer:
hydrophobically surface-modified silica particles, which are dispersed in the crosslinked product; wherein the average particle size of the silica is between 3 and 50 nm;
and
a lithium salt dispersed in the crosslinked product; or
prepared according to the preparation method of claim 8.

11. The solid polymer electrolyte of claim 10, wherein the amount of the silica particles (B) is from 1 to 30 wt. % based on the weight of the comb-branched polymer.

12. The solid polymer electrolyte of claim 10, wherein the silica particles are evenly dispersed in the electrolyte.

13. An electrochemical device, comprising:
the solid polymer electrolyte according to claim 10.

14. A device, comprising:
the electrochemical device according to claim 13.
